(19) United States
(12) Patent Application Publication
(10) Pub. No.: US 2009/0273208 A1
(43) Pub. Date: Nov. 5, 2009

(54) WINDSHIELD FRAME WITH INTEGRATED SIDE AND REARVIEW MIRRORS

(76) Inventor: CLAUDIO R. BALLARD, HUNTINGTON, NY (US)

Correspondence Address: HOWISON & ARNOTT, L.L.P, P.O. BOX 741715, DALLAS, TX, 75374-1715, US

(21) Appl. No.: 12/395,689

(22) Filed: Mar. 1, 2009

Related U.S. Application Data
(60) Provisional application No. 61/034,220, filed on Mar. 6, 2008.

(51) Int. Cl. B60J 1/02

(52) U.S. Cl. 296/201

(57) ABSTRACT

A frame for supporting a windshield, a rearview mirror and at least one side-view mirror of a vehicle. The frame comprises first and second side pillars, each side pillar having a lower end for attachment to the body of a vehicle, an upwardly extending body, and an upper end. A top member having first and second lateral ends is attached to the upper ends of the respective side pillars and a central portion extends between the lateral ends. A rearview mirror mounting structure is defined on the top member near the centerline of the vehicle, is adapted to receive a rearview mirror facing away from the front end of the vehicle, and has an areal extent, when viewed from the front end of the vehicle, that is at least coincident with the areal extent of the rearview mirror to be mounted thereto. At least one side-view mounting structure is defined on one of the top member and side pillar members at a position between the rearview mirror mounting structure and the outer lateral edges of the side pillar members. The side-view mirror mounting structure is adapted to receive a side-view mirror facing away from the front end of the vehicle, and has an areal extent, when viewed from the front end of the vehicle, that is at least coincident with the areal extent of the side-view mirror to be mounted thereon.

### CROSS-REFERENCE TO RELATED APPLICATIONS

This application claims the benefit of U.S. Provisional Application for Patent Serial No. 61/034,220, filed Mar. 6, 2008, and entitled WINDSHIELD FRAME WITH INTEGRATED SIDE AND REAR VIEW MIRRORS, the specification of which is incorporated herein in its entirety by reference.

### TECHNICAL FIELD

The following disclosure relates to body components for vehicles having windshields and mirrors and, more particularly, to a vehicle windshield frame with integrated side-view and rearview mirrors.

### BACKGROUND

It is well known to use side-view mirrors and review mirrors on vehicles such as automobiles, trucks, boats and aircraft to allow the driver/pilot to see to the rear of the vehicle without turning around. Rearview mirrors are typically mounted in front of the driver near the vehicle centerline by means of a swiveling bracket extending from the windshield, the upper windshield frame or the dashboard. In such cases, the rearview mirror obstructs a portion of the driver's view through the windshield. The rearview mirror is also visible from the front exterior of the vehicle, which may be aesthetically undesirable. A need therefore exists for a vehicle component that positions the rearview mirror such that it does not obscure the driver's view through the windshield and is not visible from the front of the car.

Side-view mirrors are typically mounted extending laterally from the sides of the vehicle, e.g., on either the front doors or the front fenders in the case of cars and trucks. The exterior mounting of the side-view mirrors often causes air turbulence between the mirror and the vehicle body at higher speeds, which may result in undesirable wind noise. To control this noise, the side-view mirrors may be mounted in streamlined housings. However, the side-view mirrors or housings extending from the sides of the vehicle adversely affect its clearance when negotiating narrow streets or entrances. Further the mirrors or housings may strike objects during parking or be struck by the doors of adjacent vehicles. A need therefore exists for a vehicle component that positions the side-view mirrors such that they do not extend laterally from the vehicle body.

### SUMMARY

The present disclosure provides, in one aspect thereof, a frame for supporting a windshield, a rearview mirror and at least one side-view mirror of a vehicle. The frame comprises first and second side pillars, each side pillar having a lower end for attachment to the body of a vehicle, an upwardly extending body, and an upper end. Each side pillar further has a front side facing the front end of the vehicle and a rear side facing away from the front end of the vehicle. A top member having first and second lateral ends is attached to the upper ends of the respective side pillars and a central portion extends between the lateral ends. The top member further has a front side facing the front end of the vehicle and a rear side facing away from the front end of the vehicle. A rearview mirror mounting structure is defined on the top member near the centerline of the vehicle. The rearview mirror mounting structure is adapted to receive a rearview mirror facing away from the front end of the vehicle. The rearview mirror mounting structure has an areal extent, when viewed from the front end of the vehicle, that is at least coincident with the areal extent of the rearview mirror to be mounted thereto. At least one side-view mounting structure is defined on one of the top member and side pillar members at a position between the rearview mirror mounting structure and the outer lateral edges of the side pillar members. The side-view mirror mounting structure is adapted to receive a side-view mirror facing away from the front end of the vehicle. The side-view mirror mounting structure has an areal extent, when viewed from the front end of the vehicle, that is at least coincident with the areal extent of the side-view mirror to be mounted thereon.

The present disclosure provides, in another aspect thereof, a frame for supporting a windshield, a rearview mirror and at least one side-view mirror of a vehicle having a programmable computer. The frame comprises first and second side pillars, each side pillar having a lower end for attachment to the body of a vehicle, an upwardly extending body, and an upper end. Each side pillar further has a front side facing the front end of the vehicle and a rear side facing away from the front end of the vehicle. A top member has first and second lateral ends attached to the upper ends of the respective side pillars and a central portion extends between the lateral ends. The top member further has a front side facing the front end of the vehicle and a rear side facing away from the front end of the vehicle. A rearview mirror mounting structure is defined on the top member near the centerline of the vehicle. The rearview mirror mounting structure is adapted to receive a rearview mirror facing away from the front end of the vehicle. The rearview mirror mounting structure has an areal extent, when viewed from the front end of the vehicle, that superposes or exceeds the areal extent of the rearview mirror to be mounted thereto. The rearview mirror mounting structure further includes a two-axis electrical adjusting (i.e., aiming) mechanism that is controllable by the vehicle's programmable computer. At least one side-view mounting structure is defined on one of the top member and side pillar members at a position between the rearview mirror mounting structure and the outer lateral edges of the side pillar members. The side-view mirror mounting structure is adapted to receive a side-view mirror facing away from the front end of the vehicle. The side-view mirror mounting structure has an areal extent, when viewed from the front end of the vehicle, that superposes or exceeds the areal extent of the side-view mirror to be mounted thereon. The side-view mirror mounting structure further includes a two-axis electrical adjusting/aiming mechanism that is controllable by the vehicle's programmable computer.

The present disclosure provides, in still another aspect thereof, an integrated windshield frame and mirror aiming system for a vehicle having a windshield. The system comprises a windshield frame/mirror assembly and a programmable computer. The windshield frame/mirror assembly is mounted on the vehicle and includes a windshield frame adapted for supporting the windshield of the vehicle, a rearview mirror mounted to the windshield frame using a first two-axis electrical aiming mechanism, a right side side-view mirror mounted to the right side of the windshield frame using a second two-axis electrical aiming mechanism and a left side side-view mirror mounted to the left side of the windshield frame using a third two-axis electrical aiming mechanism. The programmable computer is mounted in the vehicle and operatively connected to the first, second and third two-axis electrical aiming mechanisms. Aiming of the rearview mirror, the right side side-view mirror and the left side side-view mirror can be selectively changed in response to control signals sent from the computer to the respective aiming mechanisms.

### BRIEF DESCRIPTION OF THE DRAWINGS

For a more complete understanding, reference is now made to the following description taken in conjunction with the accompanying Drawings in which:

FIG. 1 illustrates the conventional placement of rearview and side-view mirrors in a vehicle according to the PRIOR ART;

FIGS. 2a and 2b illustrate a vehicle equipped with a windshield frame with integrated side-view and rearview mirrors in accordance with one aspect of the disclosure, FIG. 2a being a front view and FIG. 2b being a side view;

FIGS. 3a-3d illustrate a windshield assembly including a windshield and windshield frame having integrated side-view and rearview mirrors in accordance with another aspect of the disclosure, wherein:

FIG. 3a is a left side view;

FIG. 3b is a left front perspective view;

FIG. 3c is a left rear perspective view;

FIG. 3d is another left rear perspective view;

FIGS. 4a-4f illustrate a front view of a windshield frame having integrated side-view and rearview mirrors in accordance with a further aspect of the disclosure, wherein:

FIG. 4a is a front view;

FIG. 4b is a right side view;

FIG. 4c is a rear view;

FIG. 4d is a top view;

FIG. 4e is a bottom view;

FIG. 4f is a left side view;

FIG. 5 is a right side cross-sectional view of the windshield frame taken along line 5-5 of FIG. 4a;

FIG. 6a is an enlarged left front perspective cross-section view of a windshield frame top member showing a review mirror mounting recess in accordance with yet another aspect of the disclosure;

FIG. 6b is an enlarged left rear perspective cross-section view of the frame top member of FIG. 6a showing the review mirror mounting recess; and

FIG. 7 is a schematic diagram illustrating an integrated windshield frame having electrical adjusting/aiming mechanisms for controlling the orientation of the side-view and rearview mirrors using the vehicle's programmable computer.

### DETAILED DESCRIPTION

Referring now to the drawings, wherein like reference numbers are used herein to designate like elements throughout, the various views and embodiments of a windshield frame with integrated side and rear view mirrors. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

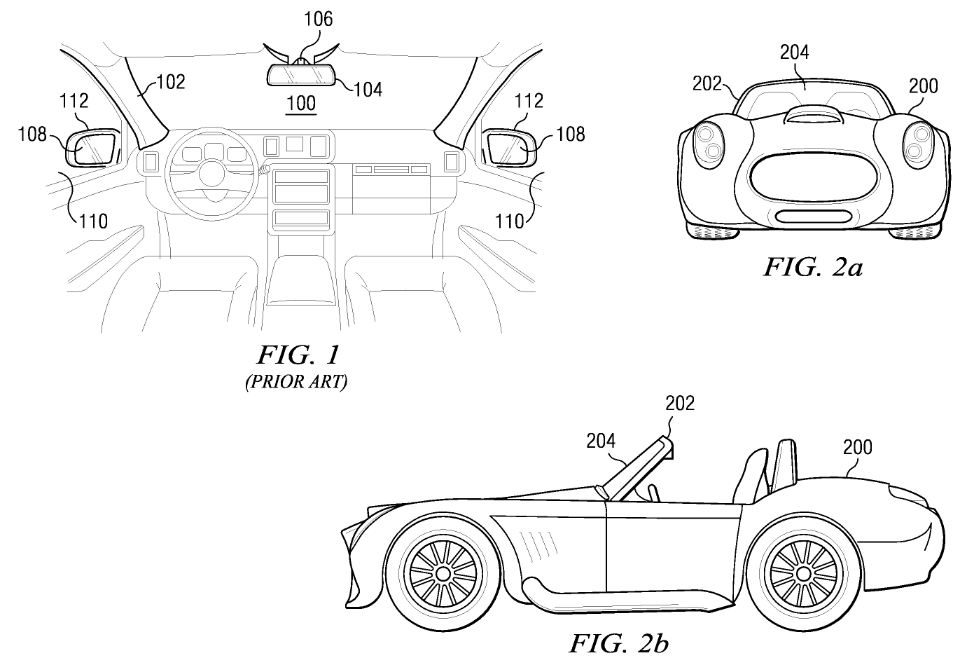

Referring now to FIG. 1, there is illustrated an interior view of a vehicle showing the conventional placement of rearview and side-view mirrors according to the prior art. Although FIG. 1 depicts the interior of an automobile, the interior of a boat, truck or airplane is typically similar. A transparent windshield 100 is located at the front end of the vehicle cockpit, supported by a windshield frame 102. In hardtop-type vehicles, the windshield frame 102 may be an integral part of the body comprising roof-supporting pillars and portions of the roof, dashboard and/or firewall, whereas in convertible- or roadster-type vehicles, the windshield frame 102 may be a free-standing structure mounted to the vehicle body at the bottom only. A rearview mirror 104 is mounted in front of the driver near the vehicle centerline by means of a swiveling bracket 106 extending from the upper portion of the windshield frame 102. In other vehicles, the bracket 106 may be mounted directly to the windshield 100 or to the dashboard. It will be appreciated that the rearview mirror 104 obstructs a portion of the driver's view through the windshield 100, and is also visible from the front exterior of the vehicle, which may be aesthetically undesirable.

Referring still to FIG. 1, conventional side-view mirrors 108 are mounted on the lateral exterior sides of the vehicle outside the side windows 110. The exterior mounting of the side-view mirrors often causes air turbulence between the mirror and the vehicle body at higher speeds, which may result in undesirable wind noise. To control this noise, the side-view mirrors 108 may be mounted in streamlined housings 112. However, the side-view mirrors 108 or housings 112 extending from the sides of the vehicle increase its overall width and adversely affect its clearance when negotiating narrow streets or entrances. Further the mirrors 108 or housings 112 may strike objects during parking or be struck by the doors of adjacent vehicles.

Referring now to FIGS. 2a and 2b, there is illustrated a vehicle equipped with a windshield frame with integrated side-view and rearview mirrors in accordance with one aspect of the disclosure. The vehicle 200 is a roadster-type automobile having an open cockpit. A windshield frame 202 is mounted to the body of vehicle 200 at the bottom only. The windshield frame 202 supports the windshield 204, as well as a rearview mirror and side-view mirrors, however, the mirrors are not visible in these views due to the novel structure of the windshield frame 202. It will be appreciated from these figures that the rearview mirror is not visible when viewed from the front exterior of the vehicle (e.g., FIG. 2a), and the side-view mirrors do not extend laterally from the sides of the vehicle.

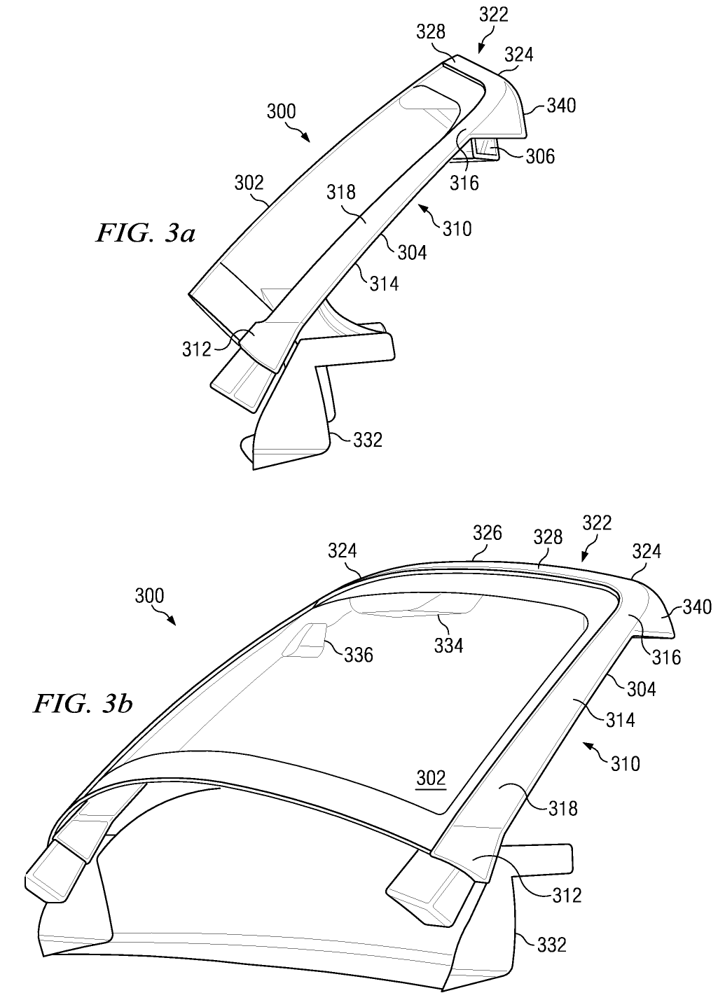

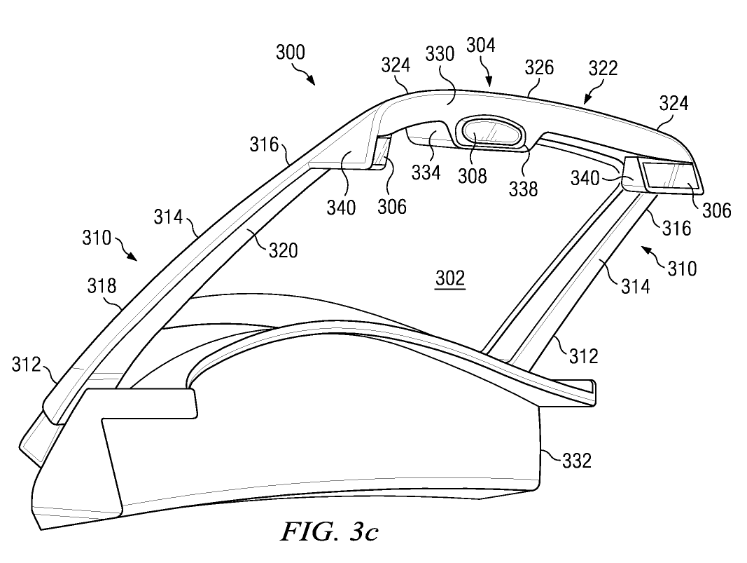

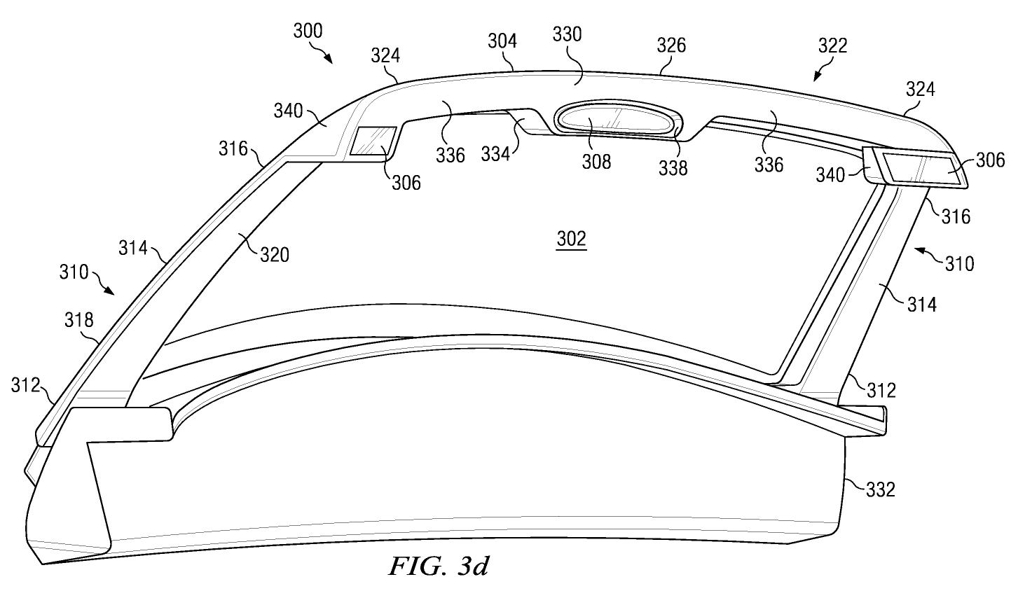

Referring now to FIGS. 3a through 3d, there is illustrated a windshield assembly in accordance with another aspect of the disclosure. The windshield assembly 300 includes a windshield 302, a windshield frame 304, side-view mirrors 306 and rearview mirror 308. The windshield frame 304 includes first and second side pillars 310, each side pillar having a lower end 312 for attachment to the body of a vehicle, an upwardly extending body 314, and an upper end 316. Each side pillar further has a front side 318 facing the front end of the vehicle and a rear side 320 facing away from the front end of the vehicle. The window frame 304 also includes a top member 322 extending between the side pillars 310. The top member 322 has first and second lateral ends 324 connected to the upper ends 316 of the respective side pillars 310, and a central portion 326 extending between the lateral ends. The top member further has a front side 328 facing the front end of the vehicle and a rear side 330 facing away from the front end of the vehicle. In the illustrated embodiment, the windshield frame 304 further includes a lower member 332 extending between the lower ends 312 of the side pillars 310. The lower member 332 may be integrated into the vehicle body to mount the windshield assembly 300 to the vehicle. The lower member 332 may not be present in all embodiments of the windshield assembly.

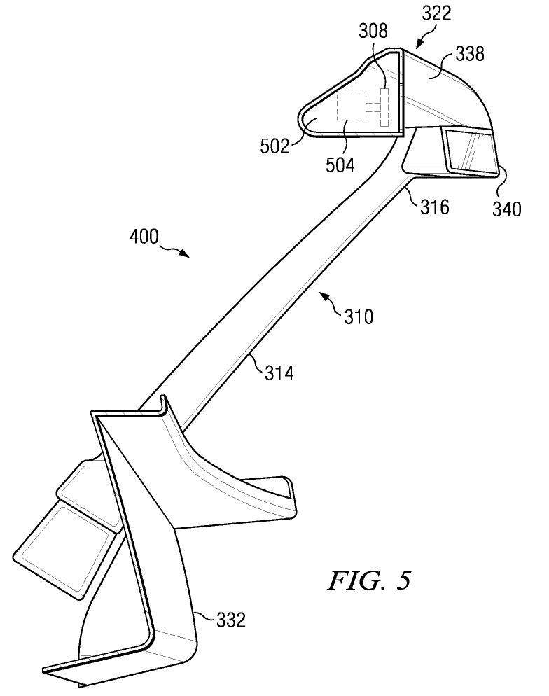

Referring still to FIGS. 3a through 3d, the windshield frame 304 further includes a rearview mirror mounting structure 334 defined on the top member 322 near the centerline of the vehicle. The rearview mirror mounting structure 334 is adapted to receive the rearview mirror 308 facing away from the front end of the vehicle. The rearview mirror mounting structure 334 preferably includes a two-axis adjusting (i.e., aiming) mechanism (e.g., FIGS. 5a and 5b) that allows the orientation of mirror 308 to be adjusted up and down and side to side. The adjusting/aiming mechanism is preferably an electrically operated adjusting/aiming mechanism, which may be operated by conventional switches or by a programmable computer located in the vehicle. In other embodiments, a manual adjusting/aiming mechanism may be provided.

The review mirror mounting structure 334 has an areal extent, when viewed from the front end of the vehicle, that superposes or exceeds (i.e., is at least coincident with) the areal extent of the rearview mirror 308. In other words, the rearview mirror mounting structure 334 is sized to be the same size, or larger than, the mirror 308 such that the rearview mirror is completely concealed behind the mounting structure when viewed through the windshield 302 from the front of the vehicle.

In the illustrated embodiment, the rearview mirror mounting structure 334 comprises a downwardly-bulged region of the top member 332 that is vertically wider that the laterally adjacent regions 336 (see FIG. 3d). In this embodiment, the rearview mirror mounting structure 334 further comprises a rearward-facing recess 338 formed in the bulged region of the top member 322. In other embodiments, the rearview mirror mounting structure 334 may comprise a flattened rear face formed on the bulged region of the top member 322. In still other embodiments, the rearview mirror mounting structure may comprise a rearward facing recess formed in a non-bulged version of top member 322.

The windshield frame 304 further includes at least one side-view mirror mounting structure 340 defined on either the top member 322 or the side pillar 310 at a position between the rearview mirror mounting structure 334 and the outer lateral edges of the side pillar members. Preferably, a side-view mirror mounting structure 340 will be positioned on each lateral (i.e., right and left) side of the windshield frame 304. In the embodiment shown, the side-view mirror mounting structures 340 are formed at the junction of the side pillars 310 and the top member 322. In other embodiments, the side-view mirror mounting structures 340 may be positioned along the side pillars 310 or along the top member 322 near the lateral ends 324.

The side-view mirror mounting structure 340 is adapted to receive a side-view mirror 306 facing away from the front end of the vehicle. The side-view mirror mounting structure 340 preferably includes a two-axis adjusting/aiming mechanism (not shown) that allows the orientation of mirror 306 to be adjusted up and down and side to side. The adjusting/aiming mechanism is preferably an electrically operated adjusting mechanism, which may be operated by conventional switches or by a programmable computer located in the vehicle. In other embodiments, a manual adjusting mechanism may be provided.

The side-view mirror mounting structure 340 has an areal extent, when viewed from the front end of the vehicle, that superposes or exceeds the areal extent of the side-view mirror 306. In other words, the side-view mirror mounting structure 340 is sized to be the same size, or larger than, the side-view mirror 306 such that the side-view mirror is completely concealed behind the mounting structure when viewed from the front of the vehicle along the centerline. Also, since the side-view mirror mounting structures 340 are positioned within the outer lateral edges of the side pillars 310, the side-view mirrors 306 do not extend beyond the sides of the windshield assembly 300.

In the illustrated embodiment, the side-view mirror mounting structures 340 comprise inwardly-bulged (i.e., bulged toward the cockpit) regions of the windshield frame that are wider that the laterally adjacent regions. In other embodiments, the side-view mirror mounting structures 340 may comprise flattened regions formed on the rear side 320 of the side pillars 310.

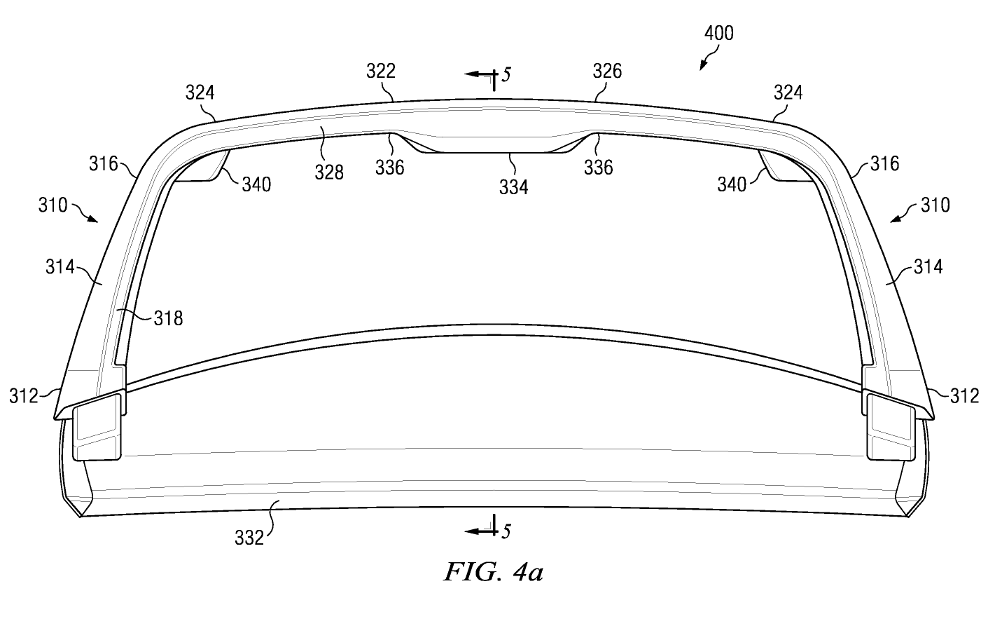

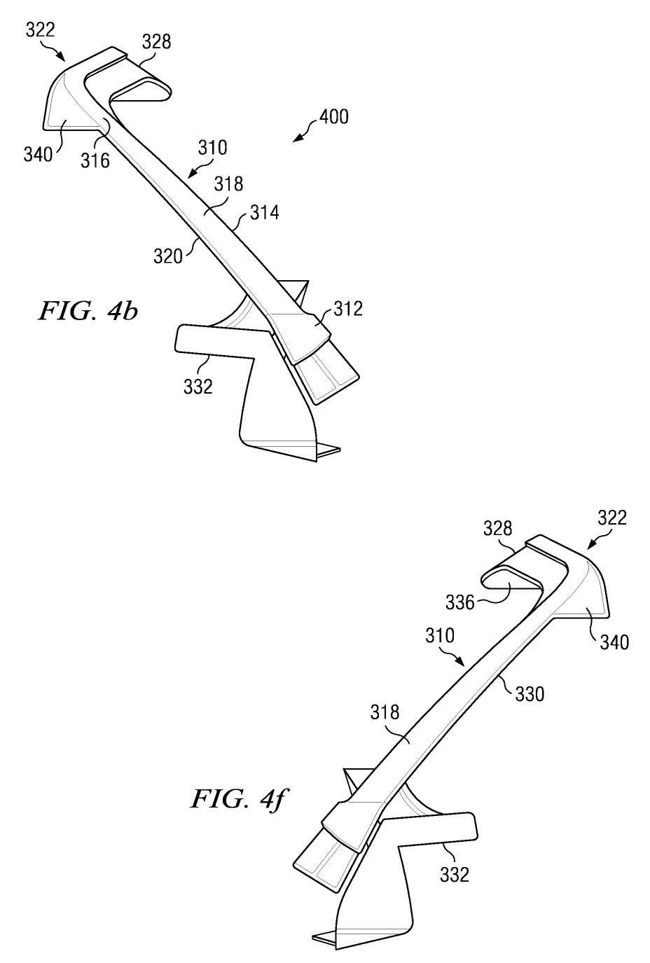

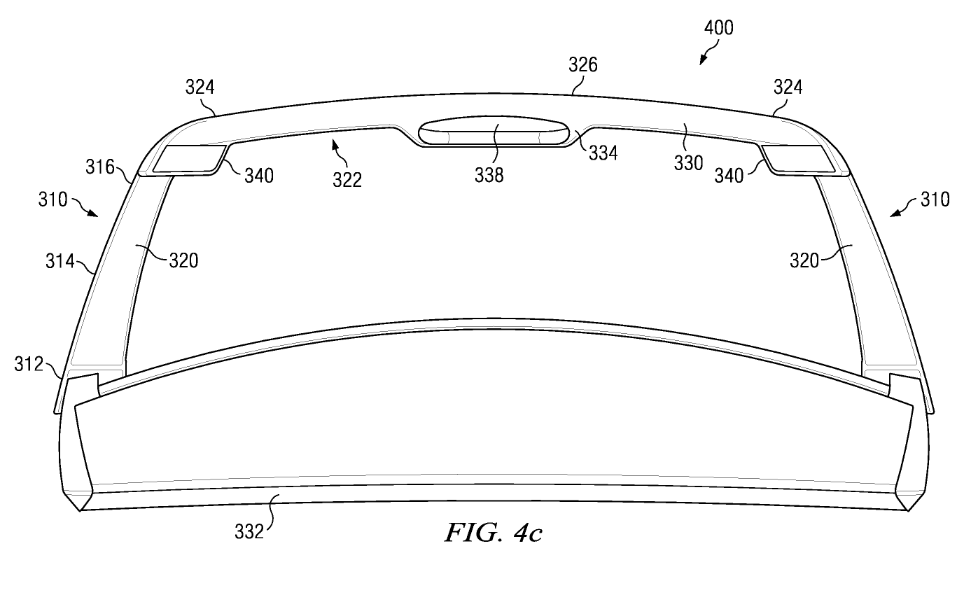

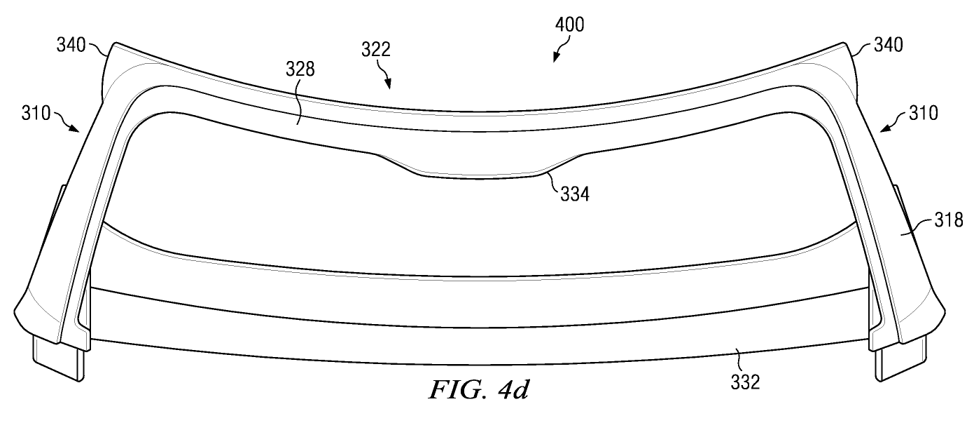

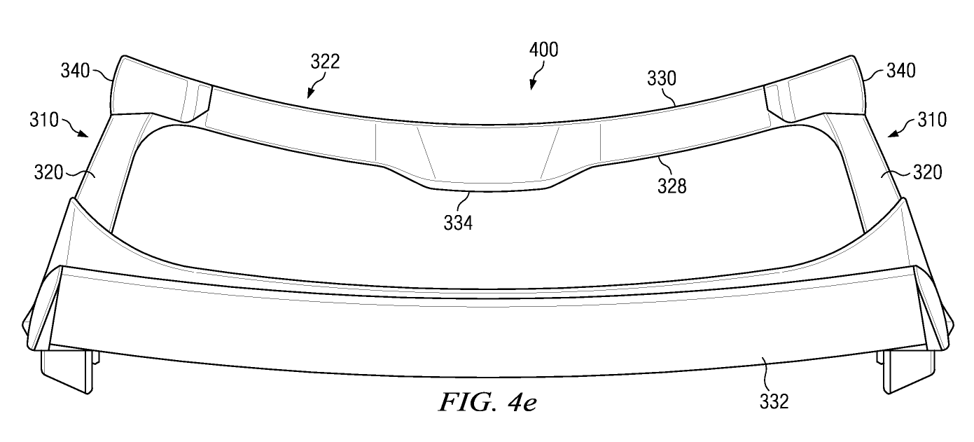

Referring now to FIGS. 4a-4f, there is illustrated a windshield frame having integrated side-view and rearview mirror mounting structures in accordance with a further aspect of the disclosure. The windshield frame 400 is substantially identical to frame 304 unless otherwise noted. Referring in particular to FIG. 4c (i.e., rear view), the rear-facing recess 338 formed in the rear side 330 of the top member is clearly illustrated.

Referring now to FIG. 5, there is illustrated a cross-section of the windshield frame 400 taken along line 5-5 of FIG. 4a. The exterior skin of the rearview mirror supporting structure 336 defines an interior cavity 502 accessible through the rear-facing recess 338. Positioned within the cavity 502 are the rearview mirror 308 (shown in phantom) and the two-axis adjusting mechanism 504 (shown in phantom).

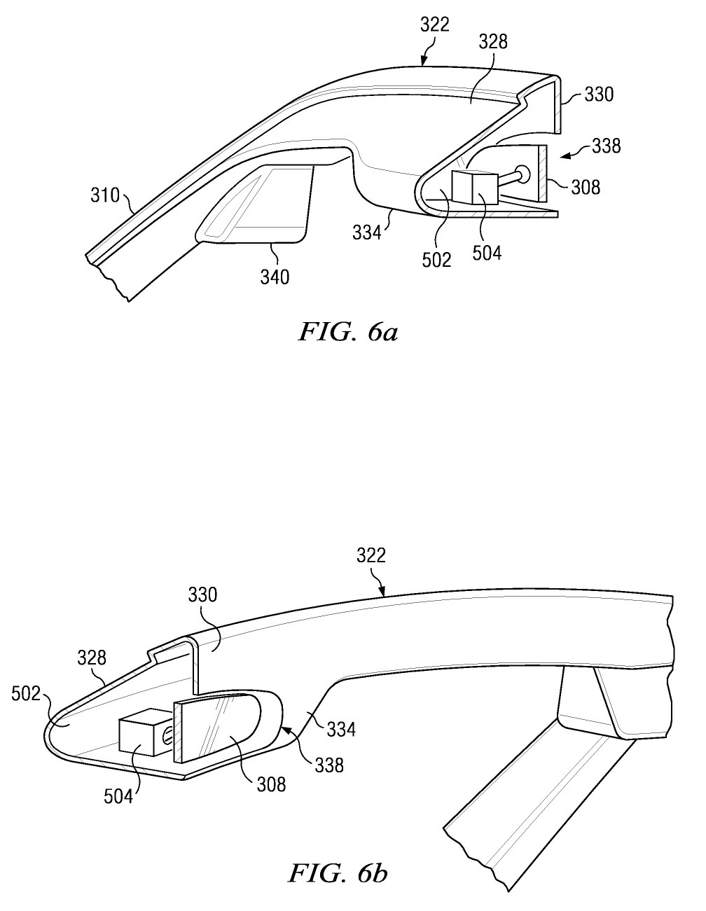

Referring now to FIGS. 6a and 6b, enlarged perspective cross-section views (FIG. 6a is a front perspective view, and FIG. 6b is a rear perspective view) of a windshield frame top member 322 are shown, taken through the vehicle centerline, to illustrate a review mirror mounting recess 338 and internal cavity 502 as previously described. Mounted within the recess 338 are the (optional) two-axis adjusting/aiming device 502 and rearview mirror 308. It will be appreciated that if the adjusting device 502 is not present, the rearview mirror 308 may be mounted directly to the frame.

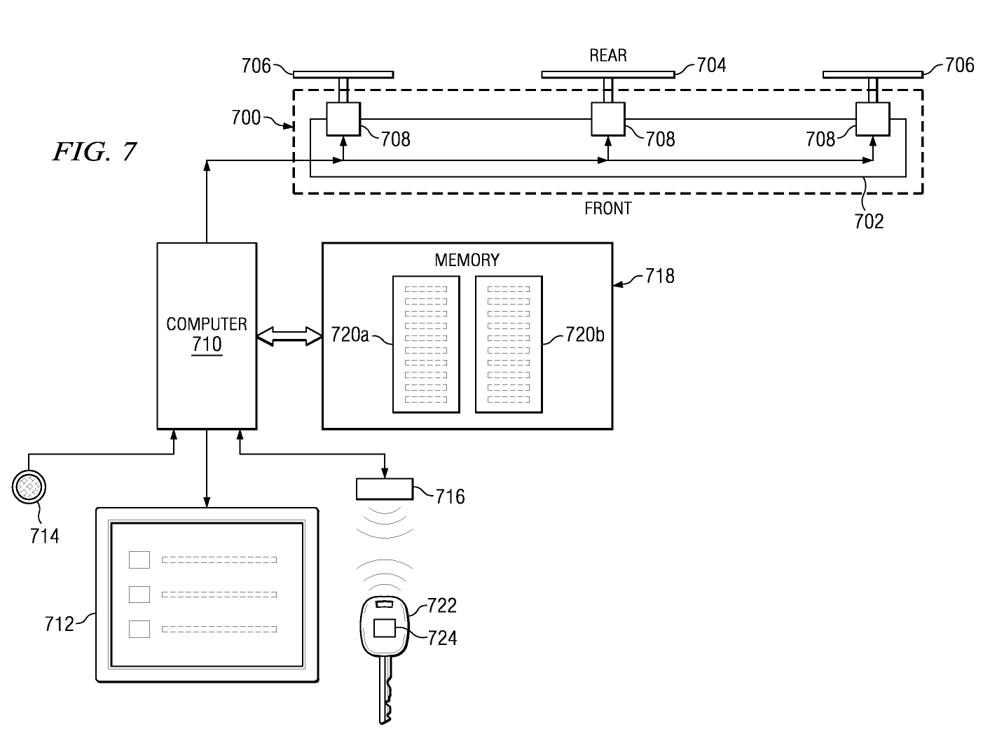

FIG. 7 is a schematic diagram illustrating an integrated windshield frame and mirror system having electrical adjusting/aiming mechanisms for controlling the orientation of the side-view and rearview mirrors using a programmable computer in the vehicle. A windshield frame/mirror assembly 700 includes a windshield frame 702, a rearview mirror 704 and two side-view mirrors 706. Each of the mirrors 704, 706 is adjustably mounted to the frame with an individual two-axis electrical adjustment mechanism 708 that can change the orientation of the mirror in response to electrical signals. In one embodiment, the windshield frame 702 has integrated rearview mirror and side-view mirror mounting structures as previously described.

Referring still to FIG. 7, the adjusting/aiming mechanisms 708 are operably connected to a programmable computer 710 located in the vehicle such that the orientation of each mirror can be controlled by the computer. The computer 710 is programmed using one or more input/output devices, for example a touch screen 712. The computer 710 may also receive inputs from sensors, for example a light sensor 714 and/or an RFID transceiver 716.

In one embodiment of the system, a first driver may adjust the orientation of each mirror 704, 706 to his/her preference by entering commands on the touch screen 712. Upon receiving the commands, the computer 710 activates the necessary adjusting mechanisms 708 to change the orientation of each mirror 704, 706. Once the preferred orientation of each mirror is achieved, the computer 710 stores the associated settings in a first driver profile 720a located in memory device 718. A second driver may then adjust the orientation of each mirror 704, 706 to a different preferred setting by entering commands on the touch screen 712, and the computer 710 will store the associated settings in a second driver profile 720b located in memory device 718. The next time either driver uses the vehicle, he/she is identified by the computer (e.g., via the touch screen 712), which then retrieves the appropriate profile from memory 718 and uses the stored settings to return all mirrors 704, 706 to the preferred orientation for that driver.

In another embodiment, each driver has a key 722 equipped with a unique RFID tag 724 or other remote identification device. When the key 722 comes into range of the vehicle's RFID transceiver 716 (or other appropriate sensor), the RFID tag 724 is detected and the computer 710 can determine which driver is approaching. The computer 710 may then automatically adjust the orientation of the mirrors 704, 706 to the preferred settings stored in the driver profile in the memory 718.

In still another embodiment, the rearview mirror 704 is of the anti-glare type having a “day” and “night” setting selectable by changing the vertical angle of the mirror. The light sensor 714 is used by the computer 710 to determine ambient (i.e., outside) lighting conditions. The computer may automatically adjust the orientation of the rearview mirror 704 to achieve the day/night setting appropriate for the ambient light detected by sensor 714.

It will be appreciated by those skilled in the art having the benefit of this disclosure that this windshield frame with integrated side and rear view mirrors provides body components for vehicles having windshields and mirrors. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1. A frame for supporting a windshield, a rearview mirror and at least one side-view mirror of a vehicle, the vehicle having a front end, a back end and a centerline, the frame comprising:
first and second side pillars;
each side pillar having a lower end for attachment to the body of a vehicle, an upwardly extending body, and an upper end;
each side pillar further having a front side facing the front end of the vehicle and a rear side facing away from the front end of the vehicle;
a top member having first and second lateral ends attached to the upper ends of the respective side pillars and a central portion extending between the lateral ends;
the top member further having a front side facing the front end of the vehicle and a rear side facing away from the front end of the vehicle;
a rearview mirror mounting structure defined on the top member near the centerline of the vehicle;
the rearview mirror mounting structure being adapted to receive a rearview mirror facing away from the front end of the vehicle;
the rearview mirror mounting structure having an areal extent, when viewed from the front end of the vehicle, that is at least coincident with the areal extent of the rearview mirror to be mounted thereto;
at least one side-view mirror mounting structure defined on one of the top member and side pillar members at a position between the rearview mirror mounting structure and the outer lateral edges of the side pillar members;
the side-view mirror mounting structure being adapted to receive a side-view mirror facing away from the front end of the vehicle;
the side-view mirror mounting structure having an areal extent, when viewed from the front end of the vehicle, that is at least coincident with the areal extent of the side-view mirror to be mounted thereon.

2. A frame in accordance with claim 1, wherein the rearview mirror mounting structure comprises an downwardly-bulged region of the top member that is vertically wider that the laterally adjacent regions and the side-view mirror mounting structure comprises an inwardly-bulged region of the frame positioned near the top end of one of the side pillars that is wider that the laterally adjacent regions.

3. A frame in accordance with claim 2, wherein the rearview mirror mounting structure further comprises a rearward facing recess formed in the bulged region of the top member.

4. A frame in accordance with claim 2, wherein the rearview mirror mounting structure further comprises a flattened rear face formed on the bulged region of the top member.

5. A frame in accordance with claim 1, wherein the rearview mirror mounting structure comprises a rearward facing recess in the top member and the side-view mirror mounting structure comprises a flattened region formed on the rear side of one of the side pillars.

6. A frame in accordance with claim 5, further comprising:
a first two-axis adjusting/aiming device mounted within the rearward facing recess of the rearview mirror mounting structure; and
a rearview mirror operatively attached to the first two-axis adjusting/aiming device and disposed within the rearward facing recess.

7. A frame in accordance with claim 6, wherein the first two-axis adjusting/aiming device is electrically operated and remotely controllable, whereby the aiming of the rearview mirror may be remotely controlled.

8. A frame in accordance with claim 7, further comprising:
a second two-axis adjusting/aiming device mounted to the side-view mirror mounting structure, the second two-axis adjusting/aiming device being electrically operated and remotely controllable; and
a side-view mirror operatively attached to the second two-axis adjusting/aiming device;
whereby both aiming of the rearview mirror and aiming of the side-view mirror may be remotely controlled.

9. A frame for supporting a windshield, a rearview mirror and at least one side-view mirror of a vehicle, the vehicle having a front end, a back end, a centerline and a programmable computer, the frame comprising:
first and second side pillars;
each side pillar having a lower end for attachment to the body of a vehicle, an upwardly extending body, and an upper end;
each side pillar further having a front side facing the front end of the vehicle and a rear side facing away from the front end of the vehicle;
a top member having first and second lateral ends attached to the upper ends of the respective side pillars and a central portion extending between the lateral ends;
the top member further having a front side facing the front end of the vehicle and a rear side facing away from the front end of the vehicle;
a rearview mirror mounting structure defined on the top member near the centerline of the vehicle;
the rearview mirror mounting structure being adapted to receive a rearview mirror facing away from the front end of the vehicle;
the rearview mirror mounting structure having an areal extent, when viewed from the front end of the vehicle, that superposes or exceeds the areal extent of the rearview mirror to be mounted thereto;
the rearview mirror mounting structure further including a two-axis electrical adjusting mechanism that is controllable by the vehicle's programmable computer;
at least one side-view mounting structure defined on one of the top member and side pillar members at a position between the rearview mirror mounting structure and the outer lateral edges of the side pillar members;
the side-view mirror mounting structure being adapted to receive a side-view mirror facing away from the front end of the vehicle;
the side-view mirror mounting structure having an areal extent, when viewed from the front end of the vehicle, that superposes or exceeds the areal extent of the side-view mirror to be mounted thereon;
the side-view mirror mounting structure further including a two-axis electrical adjusting mechanism that is controllable by the vehicle's programmable computer.

10. A frame in accordance with claim 9, wherein the rearview mirror mounting structure comprises a bulged region of the top member that is vertically wider that the laterally adjacent regions and the side-view mirror mounting structure comprises a bulged region of the frame positioned near the top end of one of the side pillars that is wider that the laterally adjacent regions.

11. A frame in accordance with claim 9, wherein the rearview mirror mounting structure comprises a rearward facing recess in the top member and the side-view mirror mounting structure comprises a bulged region of the frame positioned near the top end of one of the side pillars that is wider that the laterally adjacent regions.

12. A frame in accordance with claim 9, wherein the orientation of the rearview mirror may be moved between a plurality of predetermined positions under control of the vehicle's programmable computer.

13. A frame in accordance with claim 12, wherein some of the predetermined positions correspond to preferred positions of a plurality of drivers.

14. A frame in accordance with claim 12, wherein some of the predetermined positions correspond to alternative positions for a single driver that adjust for external lighting conditions.

15. An integrated windshield frame and mirror aiming system for a vehicle having a windshield, the system comprising:
a windshield frame/mirror assembly mounted on the vehicle, the assembly including
a windshield frame adapted for supporting the windshield of the vehicle;
a rearview mirror mounted to the windshield frame using a first two-axis electrical aiming mechanism;
a right side side-view mirror mounted to the right side of the windshield frame using a second two-axis electrical aiming mechanism;
a left side side-view mirror mounted to the left side of the windshield frame using a third two-axis electrical aiming mechanism; and
a programmable computer mounted in the vehicle and operatively connected to the first, second and third two-axis electrical aiming mechanisms;
whereby the aiming of the rearview mirror, the right side side-view mirror and the left side side-view mirror can be selectively changed in response to control signals sent from the computer to the respective aiming mechanisms.

16. An integrated windshield frame and mirror aiming system in accordance with claim 15, further comprising:
a memory device operatively connected to the programmable computer and adapted to store a plurality of mirror-aiming profiles therein;
each mirror-aiming profile including data regarding a specific orientation of the rearview mirror, a specific orientation of the right side side-view mirror and a specific orientation of the left side side-view mirror; and
whereby the computer can retrieve one of the plurality of mirror-aiming profiles from the memory device and selectively change the aiming of the rearview mirror, the right side side-view mirror and the left side side-view mirror by sending control signals to the respective aiming mechanism until the orientation of the respective mirrors matches the respective specific orientations of the retrieved mirror-aiming profile.

17. An integrated windshield frame and mirror aiming system in accordance with claim 16, further comprising:
a touch screen mounted in the vehicle and operatively connected to the programmable computer and the memory device;
the touch screen being adapted for
entry of data regarding a specific orientation of the rearview mirror, a specific orientation of the right side side-view mirror and a specific orientation of the left side side-view mirror, which data can be saved in the memory device as a mirror-aiming profile; and
selective retrieval of a previously stored mirror-aiming profile for use by the computer to selectively change the aiming of the rearview mirror, the right side side-view mirror and the left side side-view mirror by sending control signals to the respective aiming mechanism until the orientation of the respective mirrors matches the respective specific orientations of the retrieved mirror-aiming profile.

18. An integrated windshield frame and mirror aiming system in accordance with claim 16, further comprising:
a light sensor mounted in the vehicle and operatively connected to the programmable computer, the light sensor providing signals indicative of ambient lighting conditions to the programmable computer;
wherein the memory device stores mirror-aiming profiles for “day” and “night” conditions; and
whereby the programmable computer can selectively retrieve one of the “day” and “night” mirror-aiming profiles from the memory device based on the signals received from the light sensor and selectively change the aiming of the rearview mirror, the right side side-view mirror and the left side side-view mirror by sending control signals to the respective aiming mechanism until the orientation of the respective mirrors matches the respective specific orientations of the retrieved mirror-aiming profile.

19. An integrated windshield frame and mirror aiming system in accordance with claim 16, further comprising:
a RFID tag having a unique identifier;
a mirror-aiming profile associated with the unique identifier stored in the memory device; and
a RFID transceiver mounted in the vehicle and operatively connected to the programmable computer, the RFID adapted to determine the unique identifier of the RFID tag when the RFID tag is nearby and providing signals indicative of the unique identifier to the programmable computer;
whereby the programmable computer can selectively retrieve the mirror-aiming profile associated with the unique identifier from the memory device based on the signals received from the RFID transceiver and selectively change the aiming of the rearview mirror, the right side side-view mirror and the left side side-view mirror by sending control signals to the respective aiming mechanism until the orientation of the respective mirrors matches the respective specific orientations of the retrieved mirror-aiming profile.

20. An integrated windshield frame and mirror aiming system in accordance with claim 19, wherein the RFID tag is mounted on a key for the vehicle.
